(19) United States
(12) Patent Application Publication
(10) Pub. No.: US 2003/0067137 A1
(43) Pub. Date: Apr. 10, 2003

(54) Structure for fast removal of absorber for foldable bike

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/972,978

(22) Filed: Oct. 10, 2001

(51) Int. Cl. B62K 15/00; B62K 25/04

(52) U.S. Cl. 280/278; 280/284

(57) ABSTRACT

A structure for fast removal of absorber for a foldable bike includes the bottom of a seat tube being pivoted to two seat stays, a bracket of the seat tube being to pivot one end of an absorber, the other end of the absorber being vertically pivoted to the seat stays and both ends of the absorber being each provided with a through hole; the top of the bracket related to a closed surface, a retaining plate fixed to where the absorber pivoted to the set stays, both of the top surface and the retaining plate respectively holding against both ends of the absorber to define support and retainer, at least one locking pin being pivoted to either end or both ends of the absorber, one end having one or more than one set of steel bead and spring, and the other end having a cap and a pull ring.

### BACKGROUND OF THE INVENTION

(a) Field of the Invention

The present invention relates to a structure for fast removal of an absorber for a foldable bike, and more particularly to one that allows fast removal of the absorber and improves structure strength at where the absorber pivoted to the frame of the bike.

(b) Description of the Prior Art

Whereas the bike usually has the bottom of a head tube to pivot to a front wheel, a cross bar extending backward from the head tube to connect to a seat tube, and a rear fork with a rear wheel is pivoted to the bottom of the seat tube. Two pivoting plates in parallel are provided on the rear circumference of the seat tube to pivot to top of an absorber; and the bottom of the absorber is pivoted to the rear fork so that the absorber is vertically pivoted between pivoting plates and the rear fork. Both ends of the absorber are respectively provided with a through hole and pivoted with a set of bolt and nut. When riding on rough roads, the rear fork rises relatively to the seat tube to compress the absorber for shock absorption. However, the prior art as aforesaid is prevented from an easy and fast removal or mounting the absorber from or to the bike, and the absorber is also prevented from being retained and held in position. Since the support for the absorber is usually defined by having both of the upper and the lower pivoting rods respectively pivoted to the pivoting plate and the rear fork, long time execution of shock absorption causes that the points at where both of said upper and lower pivoting rods, pivoting plates and the rear fork are pivoted is subject to most of the stress. As a result, said points are vulnerable to be deformed as continuously affected by the central gravity at the cost of the structure strength of the frame.

### SUMMARY OF THE INVENTION

The primary purpose of the present invention is to provide a structure for fast removal of an absorber for a foldable bike that permits fast removal or mounting of the both ends of the absorber from to the frame of the bike where the absorber is pivoted to, and that improve the structure strength to where the pivot takes place by means of a retainer. To achieve the purpose, a bracket is provided at the rear circumference of the seat tube under the seat for pivoting the upper end of the absorber. The lower end of the seat tube is pivoted to the seat stay extending backward for pivoting the lower end of the absorber. Both ends of the absorber are each provided with a through hole. The top of the bracket is a closed surface. A retaining plate is fixed to the seat stay in relation to where the absorber is pivoted. A support and a retainer are provided by means of having the top of the bracket and the retaining plate respectively to hold against both ends of the absorber. At least one locking pin is pivoted to either end or both ends of the absorber. One end of the locking pin is provided with at least one set of steel bead and spring. The steel bead is partially exposed from the circumference of the locking pin as pushed by the spring and the other end of the locking pin is provided with a cap and a pull ring.

Another purpose of the present invention is to provide a structure for fast removal of an absorber for a foldable bike that improves the structure strength at where the absorber is pivoted to the frame of the bike so to prevent the frame from deformation for being long time under excessive stress. To achieve this purpose, a bracket to pivot the absorber is provided behind the rear circumference of the seat tube pivoted at its top to the seat. The bottom of the seat tube is pivoted to seat stays extending backward to pivot a rear wheel and the bottom of the absorber is vertically pivoted to the seat stays. The improvement is essentially made at that the top of the bracket of the seat tube is a closed surface and a retaining plate is fixed at where the absorber is pivoted relatively to the seat stays. A support is formed by having both of the top surface of the bracket and the retaining plate respectively to hold against both ends of the absorber to reinforce the structure strength at where both ends of the absorber are pivoted to the frame of the bike.

### BRIEF DESCRIPTION OF THE DRAWINGS

FIG. 1 is an exploded view of a preferred embodiment of the present invention,

FIG. 2 is a perspective view of the locking pin of the preferred embodiment of the present invention,

FIG. 3 is a side view of the preferred embodiment of the present invention;

FIG. 4 is an exploded view of another preferred embodiment of the present invention;

FIG. 5 is an exploded view of another preferred embodiment of the present invention (with the locking pin provided only at the lower end of the absorber); and

FIG. 6 is an exploded view of another preferred embodiment of the present invention (with the locking pin provided only at the upper end of the absorber).

### DETAILED DESCRIPTION OF THE PREFERRED EMBODIMENTS

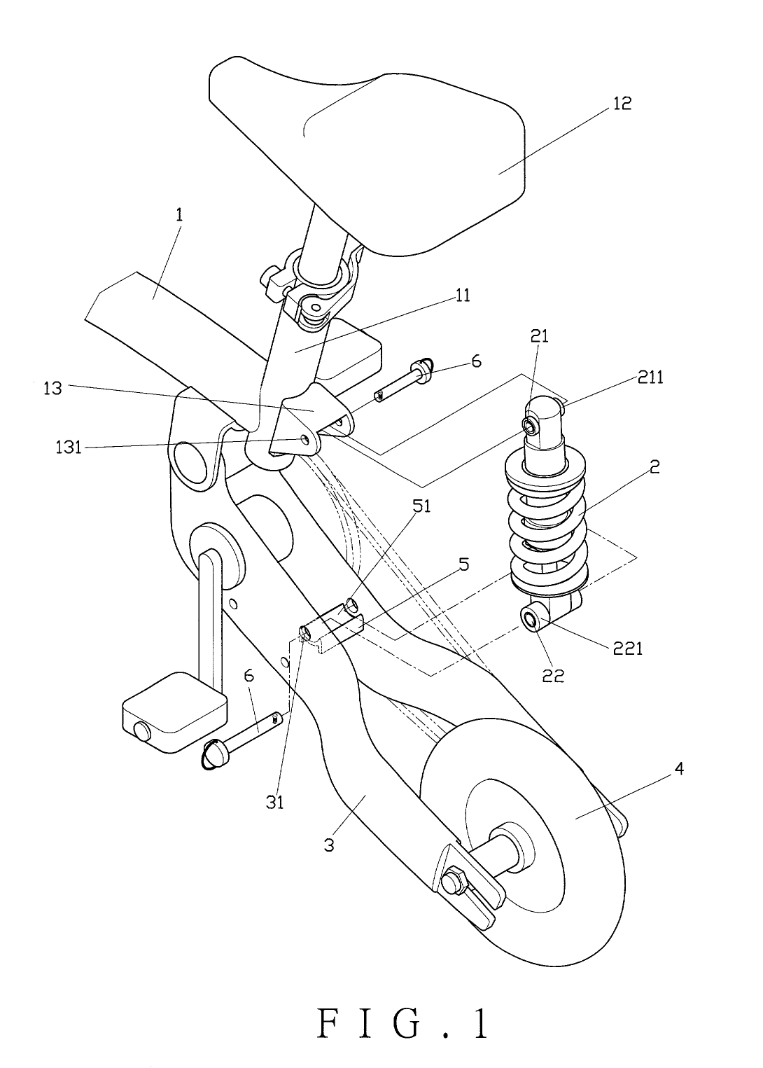

Referring to FIG. 1 for a preferred embodiment of the present invention, the top of a seat tube (11) of a bike (1) receives a seat (12), and an absorber (2) is vertically pivot to an arc bracket (13) mounted to the rear circumference of the seat tube (11). Two seat stays (3) extending backward in parallel are pivoted to the lower end of the seat tube (11) and a rear wheel (4) is pivoted to and between said two seat stays (3).

The top of the bracket (13) of the seat tube (11) is a closed surface while one through hole (131) each is provided to both sides of the bracket (13) to receive insertion of a locking pin (6) penetrating the top of the absorber (2).

A through hole (31) is provided through in each of said two seat stays (3) in relation to a pivot (22) disposed at the bottom of the absorber (2). A retaining plate (5) connected to the inner side of the seat stay (3) is welded near to the bottom of the through hole (31). The retaining plate (5) is in the shape of a staple (17) having a concave guarding surface (51). Both sides of the retaining plate (5) respectively hold against the inner side of the seat stay (3) with the guarding surface (51) facing upward.

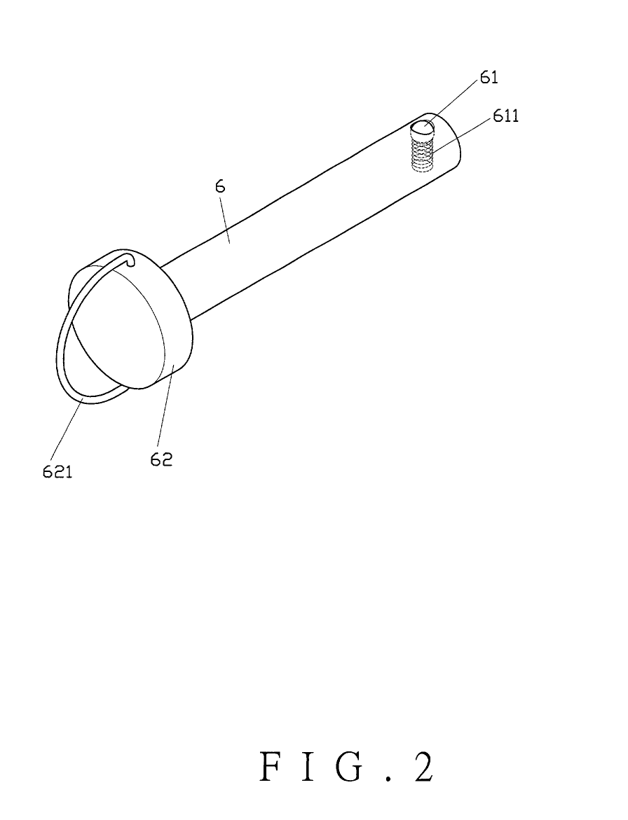

As illustrated in FIG. 2, the locking pin (6) has one end provided one set of steel bead (61) and spring (611) (more than one set will even further secure the locking). For being pushed against by the spring (611), the steel bead is (61) partially exposed from the circumference of the locking pin (6). The other end of the locking pin (6) is a cap (62) with a pull ring (621).

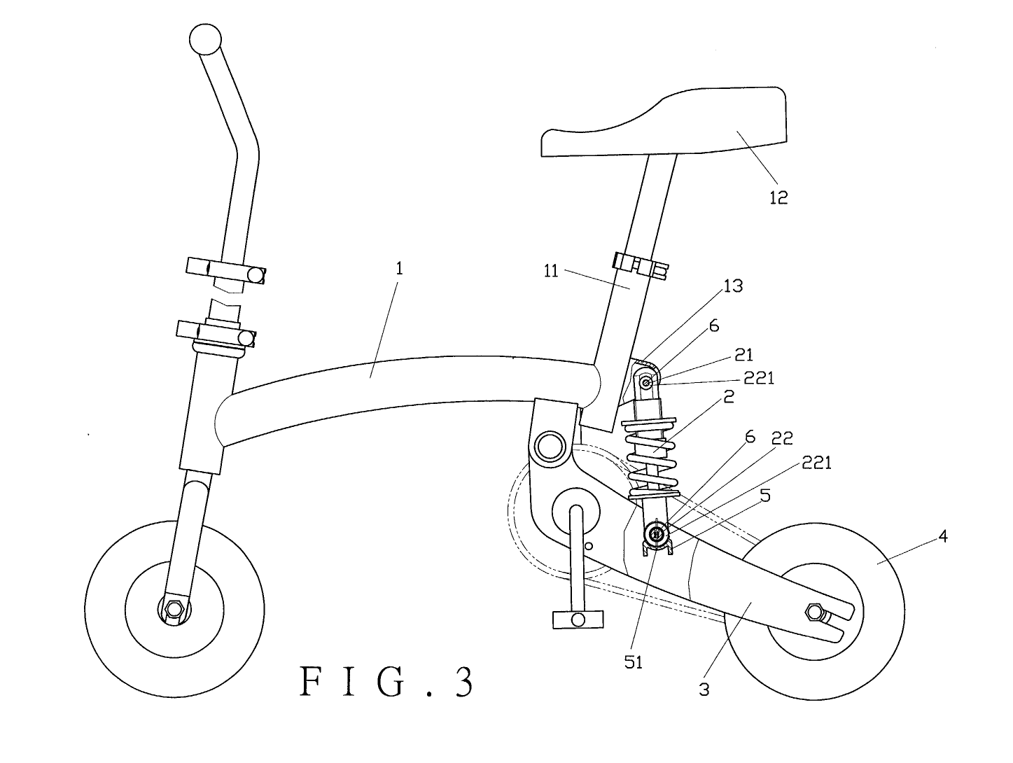

Upon assembling as illustrated in FIG. 3, an upper pivot (21) of the absorber (2) is pivoted to the bracket (13) by having the locking pin (6) to penetrate two retainers (211) on both sides of the upper pivot (21) and the through holes (131). The upper pivot (21) of the absorber (2) is locked in position by the steel bead (61). Since the top of the bracket (13) is a closed surface, the top of the absorber (2) is allowed to hold against the top of the bracket (13), The top of the bracket (13) functions as a support and a retainer at the same time, making for the locking pin (6) easy to aim at the through hole (131). The pivot (22) at the bottom of the absorber (2) and two retainers (221) are pivoted to the through holes (31) respectively provided in the two seat stays (3) with the locking pin (6) and locked in position with its steel bead (61). Thus the lower end of the absorber (2) is pivoted to the seat stays (3) and holds against the guarding surface (51) of the retaining plate (5). The guarding surface (51) functions as a support and a retainer at the same time for the locking pin (6) to aim at the through holes (31).

When riding on a rough road, the seat stays (3) having the point at where they are pivoted to the seat tube (11) as a center of rotation rise to compress in relation to the absorber (2). The pivot (22) and the retainers (221) on the bottom of the absorber (2) are restricted at the same time by the retaining plate (5). Therefore, both of the pivot (22) and the retainers (221) are compressed for being subject to the force from the retaining plate (5) in relation to the absorber (2). In this way, deformation to the circumference of the through hole (31) pivoting the absorber (2) on the seat stays (3) by excessive and concentrated stress is avoided. The top of the absorber (2) holds against the top of the bracket (13), which forms a support for the absorber (2) when compressed. Thus, deformation to the through holes (131) of the bracket (13) resulted from excessive and concentrated stress is avoided. Upon executing a fast removal for folding the bike, simply pull the pull ring (621) to force the bead (61) to retreat into the locking pin (6) so to pull out the locking pin (6) out of the bracket (13) or the seat stays (3).

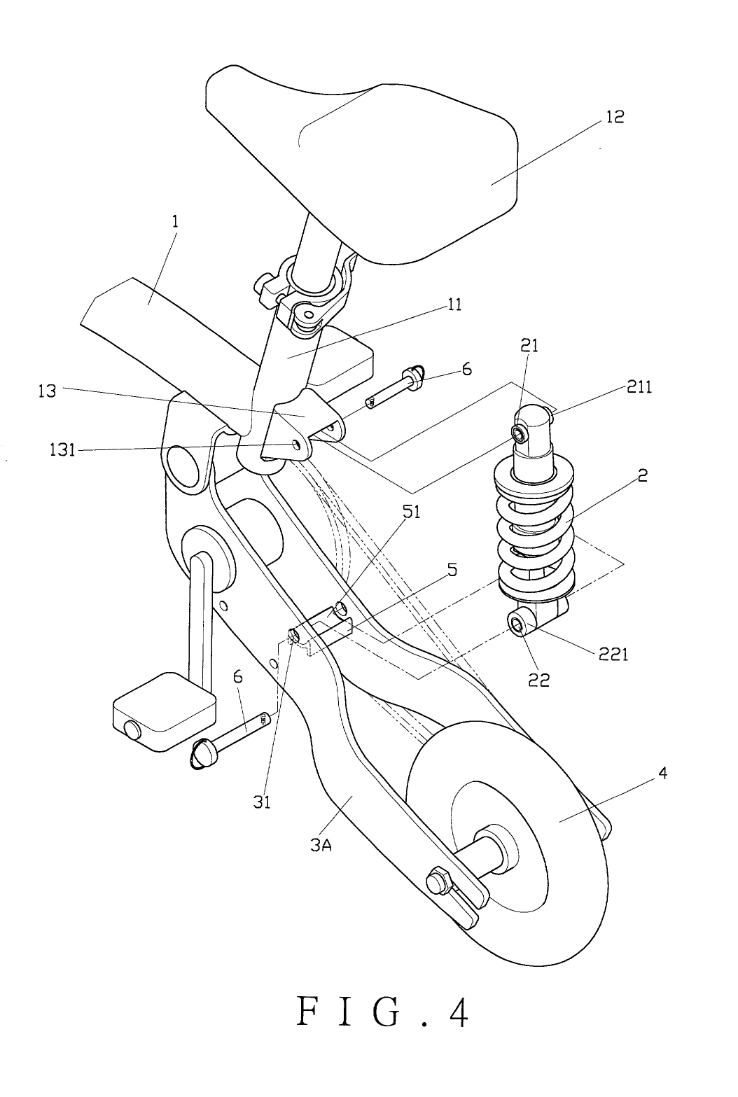

Now referring to FIG. 4 for another preferred embodiment of the present invention, wherein, it is composed of members similar to those disclosed in the first preferred embodiment with the only difference in that two seat stays (3A) are each made in a form of flat plate.

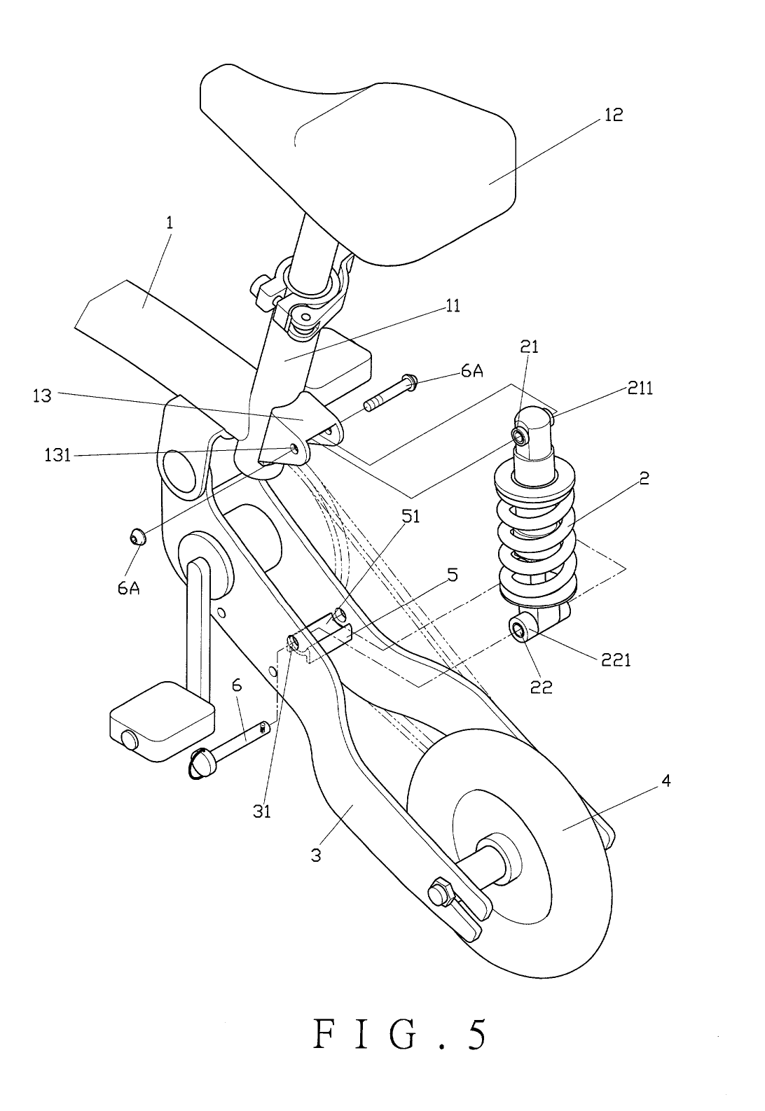

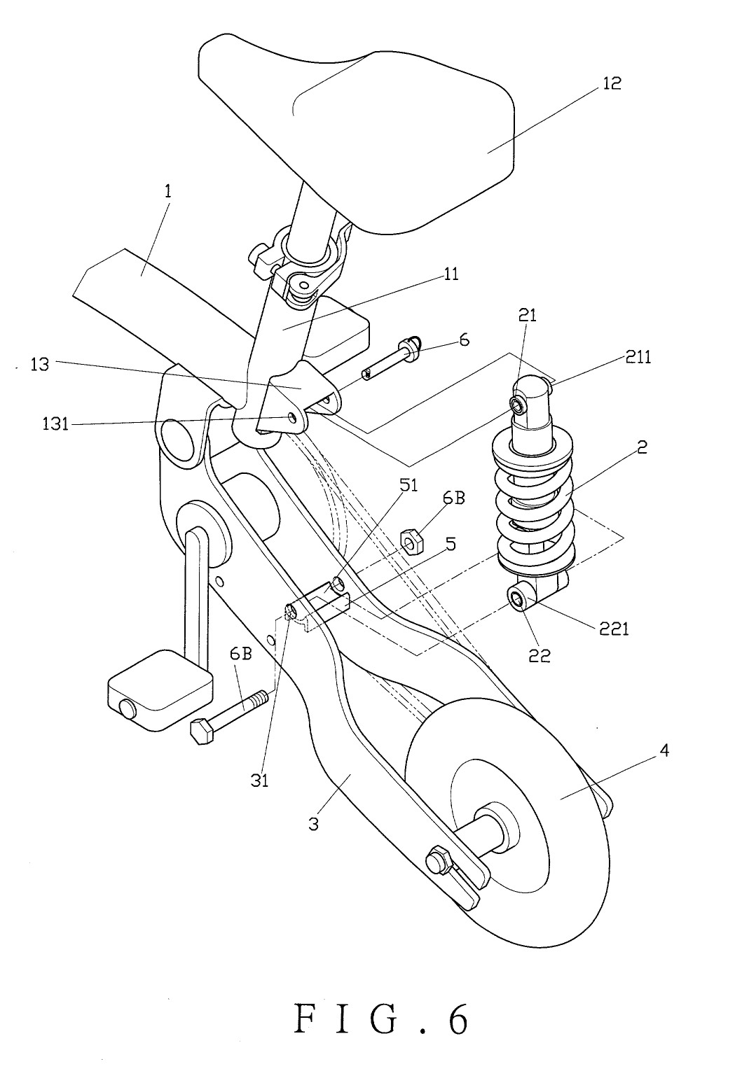

FIG. 5 shows another preferred embodiment of the present invention. The locking pin (6) is only provided at the lower end of the absorber (2) while the upper end of the absorber (2) is pivoted with a bolt and nut set (6A). FIG. 6 shows another further preferred embodiment of the present invention. The locking pin (1) is provided only to the upper end of the absorber (2) while the lower end of the absorber (2) is pivoted with a bolt and nut set (6B). In fact, the locking pin (6) provided to either end of the absorber is sufficiently convenient for fast removal.

As disclosed, the structure for fast removal of an absorber for a foldable bike of the present invention allows fast removal of the absorber to fold the bike and improve of the structural strength to where the absorber is pivoted to the frame of the bike. Upon mounting the absorber to the bike, the absorber is readily in a position to facilitate the locking pin to aim at the through holes provided either in the seat stays or in both sides of the bracket.

I claim:

1. A structure of fast removal of absorber for a foldable bike, wherein, the bottom of a seat tube of the bike being pivoted to two seat stays extending backward, a bracket provided behind the rear circumference of the seat tube to pivot one end of a absorber, the other end of the absorber being vertically pivoted to the seat stays and both ends of the absorber being each provided with a through hole characterized by that:
the top of the bracket related to a closed surface, a retaining plate being fixed to where the seat stays being pivoted relatively to the absorber, both of the top surface of the bracket and the retaining plate of the seat stays respectively holding against both ends of the absorber to define support and retainer, at least one locking pin being pivoted to either end or both ends of the absorber, one end of the locking pin being provided with one or more than one set of steel bead and spring, the steel bead as pushed by the spring being partially exposed from the circumference of the locking pin, and the other end of the locking pin being provided with a cap with a pull ring.

2. A structure of fast removal of absorber for a foldable bike as claimed in claim 1, wherein, the retaining plate is provided with a concave guarding surface to hold against the bottom of the absorber with the guarding surface facing upward.
